(19) United States
(12) Patent Application Publication
(10) Pub. No.: US 2007/0108863 A1
(43) Pub. Date: May 17, 2007

(54) Stator for an electrical machine

(76) Inventors: Hubert Bischof, Vaihingen/Enz (DE); Frank Stambulic, Ludwigsburg (DE); Reinhard Meyer, Bietigheim-Bissingen (DE); Istvan Ragaly, Schwieberdingen (DE)

Correspondence Address: MICHAEL J. STRIKER, 103 EAST NECK ROAD, HUNTINGTON, NY, 11743, US

(21) Appl. No.: 10/573,629

(22) PCT Filed: Sep. 29, 2004
(86) PCT No.: PCT/EP04/52354

§ 371 Date: Dec. 22, 2006

(30) Foreign Application Priority Data
Sep. 30, 2003 (DE) 103 47 486.2

(51) Int. Cl. H02K 1/00; H01F 7/06; H02K 19/26

(52) U.S. Cl. 310/180; 29/606; 322/29; 310/184

(57) ABSTRACT

A stator of a three-phase generator, having a multi-strand stator winding in which each of the m phase windings (19)
is comprised of a group (22), which
   has a first coil (24) with coil sides (28, 29), which are contained in grooves (16) that are spaced apart from one another by 180° electrically and the first coil (24) has a particular number of turns (z_{w}),
   has a second coil (27) with coil sides (29, 30), which are contained in grooves (16) that are spaced apart from one another by 180° electrically and the second coil (27) has a particular number of turns (z_{w});
   the second coil (27) is offset from the first coil (24) in a first direction by 180°/m electrically, and
in accordance with the predetermined number of pole pairs, a corresponding number of groups (22) that are offset from one another by 360° electrically are arranged one after another in the stator.

### PRIOR ART

The invention relates to a stator for an electrical machine, in particular for a three-phase generator for motor vehicles, having an annular laminated stator core that has a multitude of grooves parallel to one another into which the phase windings are inserted.

Three-phase generators of this kind are sufficiently well-known from the prior art. They are used in particular as generators in motor vehicles. So-called claw-pole generators have gained acceptance due to their advantages with regard to size, manufacture costs, and ruggedness.

A claw-pole generator usually includes a rotor that accommodates the excitation winding and an annular stator encompassing it, which accommodates the three-phase windings. For this purpose, the stator, which is embodied in the form of a laminated core, is provided with a multitude of grooves that extend axially parallel to one another and are spaced uniformly apart from one another. The windings for the three phases are then inserted into the grooves in a particular winding scheme in which only windings of the same phase are contained in one groove.

When used in motor vehicles, the problem of noise generation plays an important role in the development of three-phase generators. In particular, the changing magnetic fields in the air gap contribute to this problem; the air gap field is generated by the superposition of the main rotor field and the armature reaction field of the stator.

Various countermeasures are taken against this magnetic noise, for example enlargement of the air gap or tightening of production tolerances. An effective measure for reducing noise is the so-called claw cutting method, a beveling of the trailing pole tips of the rotor.

This change in the claw pole shape reduces the effects of armature reaction of the stator currents, which, with electrical loading of the generator, causes powerful field distortion in the air gap and thus generates noise.

Other changes in the claw pole shape are also executed to reduce noise generation.

All of these measures, however, mean that different claw-pole rotors must be manufactured and stored for generators with a different current/speed characteristics and for generators that are of the same type, but are destined for use in different applications. This entails high production and storage costs.

### ADVANTAGES OF THE INVENTION

The stator according to the invention with the defining characteristics of claim 1 has the advantage that a noise reduction is achieved through an intervention in the stator winding. Furthermore, achieving this noise reduction does not require any change to the claw poles or any change to their shape, which reduces production and storage costs.

The fact that out of all the conductors of a phase winding, at least one conductor is shifted by at least one groove in relation to the conventional winding scheme makes it possible to influence the shape of the air gap field so that a noise reduction is achieved.

Advantageous modifications and improvements of the three-phase generator disclosed in claim 1 are possible by means of the measures disclosed in the dependent claims.

### DRAWINGS

Two exemplary embodiments of the invention will be explained in greater detail below in conjunction with the drawings.

FIG. 1 shows a winding scheme of an offset wave winding according to a first exemplary embodiment of the invention,

FIG. 2 shows a winding scheme of an offset wave winding according to a second exemplary embodiment of the invention,

FIG. 3 shows a noise level graph for three different winding schemes.

### DESCRIPTION

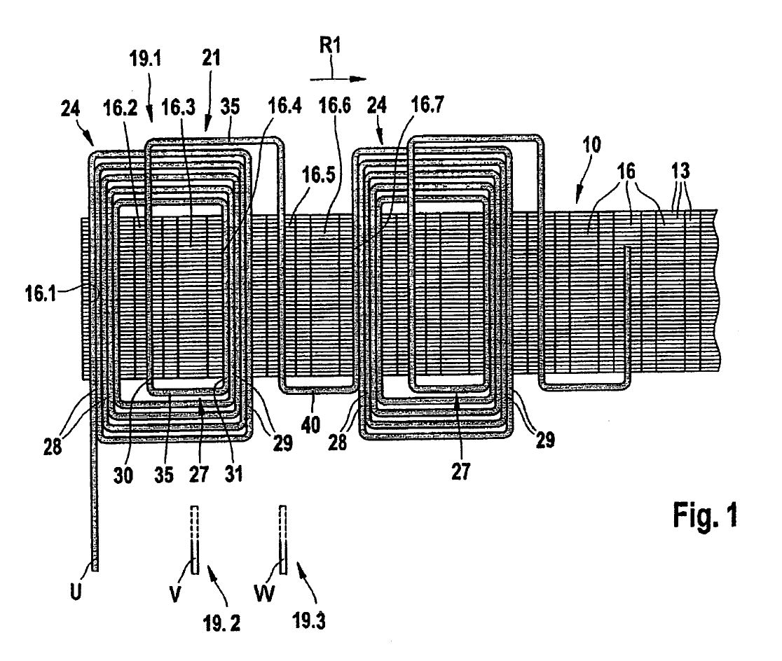

FIG. 1 is a top view of an essentially flat stator iron 10, which is constituted by a packet of individual strip-shaped laminae 13 placed against one another. In a three-phase machine, a total of three phase windings 19 of a stator winding 21 are inserted into the flat stator iron 10, for example equipped with 36 or 48 grooves 16; only one phase winding 19.1 with the phase winding end U is shown in this case. The beginnings V and W of the two other phase windings are also depicted.

The phase winding 19.1 is comprised of a multiple of a group 22 of several coils, a first coil 24 and a second coil 27. The first coil 24 has first coil sides 28 and second coil sides 29, which are inserted into grooves 16 that are spaced apart from one another by 180° electrically. The first coil 24 has a certain number of turns z_{w}; in the example, z_{w}=5. The second coil 27 likewise has first coil sides 30 and second coil sides 31, which are, in turn, inserted into grooves 16 that are spaced apart from one another by 180° electrically. The second coil 27 has a certain number of turns z_{w}; in the example, z_{w}=1. This therefore yields a winding ratio of 5:1. The second coil 27 is offset from the first coil 24 in a first direction R1 by 180°/m electrically. In a three-phase generator with three phase windings, m=3, which means that the offset between the first coil 24 and the second coil 27 is 60° electrically. In accordance with the number of pole pairs predetermined for an electrical machine, a corresponding number of groups 22 that are offset from one another by 360° electrically are arranged one after another in the stator. If the electrical machine has six or eight pole pairs, then the stator is correspondingly provided with six or eight groups 22. This therefore yields the number six or eight as the previously mentioned multiple.

Accordingly, the first group 22 of the phase winding 19.1 is arranged as follows in the grooves 16: the first coil sides 28 are contained in the first groove 16.1, the second coil sides 29 are contained in the fourth groove 16.4. The first coil sides 30 are contained in the second groove 16.2, the second coil sides 31 are contained in the fifth groove 16.5.

Starting from the phase winding beginning U, the first group 22 is wound as follows: the first coil 24 with the number of turns z_{w}=5 is placed into the grooves 16.1 and 16.4. After the last second coil side 29, a coil side connector 35 leads from it to the first coil side 30 in the groove 16.2 of the second coil 27. In the example, this coil side 30 is followed by an additional coil side connector 35 that leads to the second coil side 31 of the second coil 27. The second coil side 31 of the second coil 27 is inserted into the groove 16.5. A group connector 40 leads from this second coil side 31, extends to the groove 16.7, and then transitions there into a first coil side 28 of the first coil 24 of the second group 22.

A second phase winding 19.2 is situated with its coil sides, coil side connectors, and group connector in precisely the same manner, but with the difference that all the corresponding phase winding regions are offset by 360°/m electrically in the direction R1. The second phase winding 19.2 thus starts offset by 120° electrically, with the phase winding beginning V in the groove 16.3, the third phase winding 19.3 starts with the phase winding beginning W in the groove 16.5, and so forth.

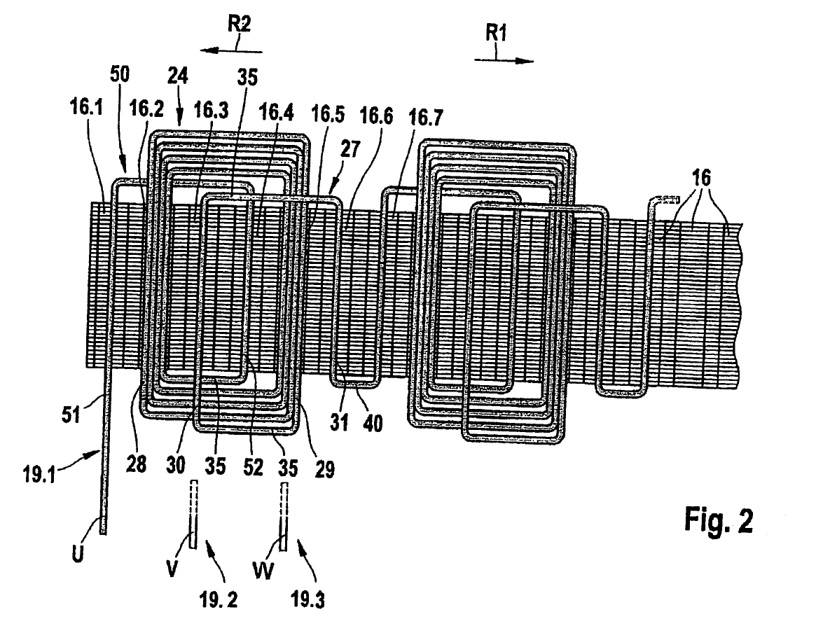

FIG. 2 also shows a top view of an essentially flat stator iron 10. A total of three phase windings 19 of a stator winding 21 are inserted into the flat stator iron 10, for example equipped with 36 or 48 grooves 16; in this case, too, only the phase winding 19.1 with the phase winding end U is shown.

The phase winding 19.1 is likewise comprised of a group 22 of several coils, a first coil 24, a second coil 27, and a third coil 50. The first coil 24 has first coil sides 28 and second coil sides 29 that are inserted into grooves 16, which are spaced apart from one another by 180° electrically. The first coil 24 has a certain number of turns z_{w}; in the example, z_{w}=4. The second coil 27 likewise has first coil sides 30 and second coil sides 31, which are, in turn, inserted into grooves 16 spaced apart from one another by 180° electrically. The second coil 27 has a certain number of turns z_{w}; in the example, z_{w}=1. The second coil 27 is offset from the first coil 24 in a first direction R1 by 180°/m electrically. The third coil 50 likewise has first coil sides 51 and second coil sides 52, which are inserted into grooves 16 that are spaced apart from one another by 180° electrically. The third coil 50 has a certain number of turns z_{w}; in the example, z_{w}=1. The third coil 50 is offset from the first coil 24 in a second direction R2 by 180°/m electrically. The second direction R2 is opposite from the first direction R1. The third coil 50 has fewer turns than the first coil 24.

In a three-phase generator with three phase windings, m=3, which means that the offset between the first coil 24 and the second coil 27 is 60° electrically. The offset between the first coil and the third coil is −60° electrically. In accordance with the number of pole pairs predetermined for an electrical machine, a corresponding number of groups 22 that are offset from one another by 360° electrically are arranged one after another in the stator. If the electrical machine has six or eight pole pairs, then the stator is correspondingly provided with six or eight groups 22.

Accordingly, the first group 22 of the phase winding 19.1 is arranged as follows in the grooves 16: the first coil sides 28 are contained in the second groove 16.2, the second coil sides 29 are contained in the fifth groove 16.5. The first coil sides 30 are contained in the third groove 16.3, the second coil sides 31 are contained in the sixth groove 16.6. The first coil sides 51 are contained in the first groove 16.1, the second coil sides 52 are contained in the fourth groove 16.4.

Starting from the phase winding beginning U, the first group 22 is wound as follows: first, the third coil 50 with the number of turns z_{w}=1 is placed into the grooves 16.1 and 16.4. After the last second coil side 52, a coil side connector 35 leads from it to the first coil side 28 of the first coil 24 and thus transitions into the first coil side 28. The first coil 24 with the number of turns z_{w}=4 is placed into the grooves 16.2 and 16.5. After the last second coil side 29, a coil side connector 35 leads from it to the first coil side 30 in the groove 16.3 of the second coil 27. In the example, this coil side 30 is followed by an additional coil side connector 35 that leads to the second coil side 31 of the second coil 27. The second coil side 31 of the second coil 27 is inserted into the groove 16.6. A group connector 40 leads from this second coil side 31 to the groove 16.7, and then transitions there into a first coil side 28 of the third coil 50 of the second group 22.

A second phase winding 19.2 is situated with its coil sides, coil side connectors, and group connector in precisely the same manner, but with the difference that all the corresponding phase winding regions are offset by 360°/m electrically in the direction R1. The second phase winding 19.2 thus starts with the phase winding beginning V in the groove 16.3, the third phase winding 19.3 starts with the phase winding beginning W in the groove 16.5, and so forth.

Generally speaking, the phase windings 19 can be wound either with a single-strand wire or with a multi-strand wire. The term multi-strand wire means that two or more parallel wires are wound at the same time during the winding process.

With regard to the number of turns, the following ratios have turned out to be favorable for 14 V generators:

z_{w} of the first coil/z_{w} of the second coil: 4:1; 5:1; 6:1; 7:1; 8:1; 2:4; 4:2; 2:5; 5:2; 2:6; 6:2; 3:6; 6:3; 2:7; 7:2; 2:8; 8:2; 6:4; 4:6

z_{w} of the first coil/z_{w} of the second coil/z_{w} of the third coil: 1:4:1; 1:5:1; 1:6:1

The stator is a so-called flat-packet stator. This means that the stator is manufactured according to a particular manufacturing process. In this process, an essentially flat stator iron 10 that is constituted by a packet of individual strip-shaped laminae 13 placed against one another; a winding is inserted into the grooves 16 and then the stator iron 10 is bent into a circle along with the winding so that its electrical properties essentially correspond to those of conventional annular stators. Before being inserted, the coil sides of the winding, i.e. of the phase windings 19, are shaped in a die so that the coil sides provided for a groove 16 are adapted to a groove contour after being bent into a circle. The stator is intended for use as the stator of a three-phase machine, in particular a three-phase generator.

Through appropriate selection of the offset ratio of the conductors, the magnetic field in the air gap can be shaped by changing the armature field in such a way as to reduce the magnetic noise.

Measurements have shown that starting from a certain speed, the generator current of a generator with an offset winding is greater than that of a conventionally designed generator. The current supplied by the conventional generator is only greater at low speeds. However, this can be compensated for very easily by increasing the total number of conductors or by elongating the stator iron, as long as the current supplied to the partially offset winding at low generator speeds is not equivalent to the minimum requirements.

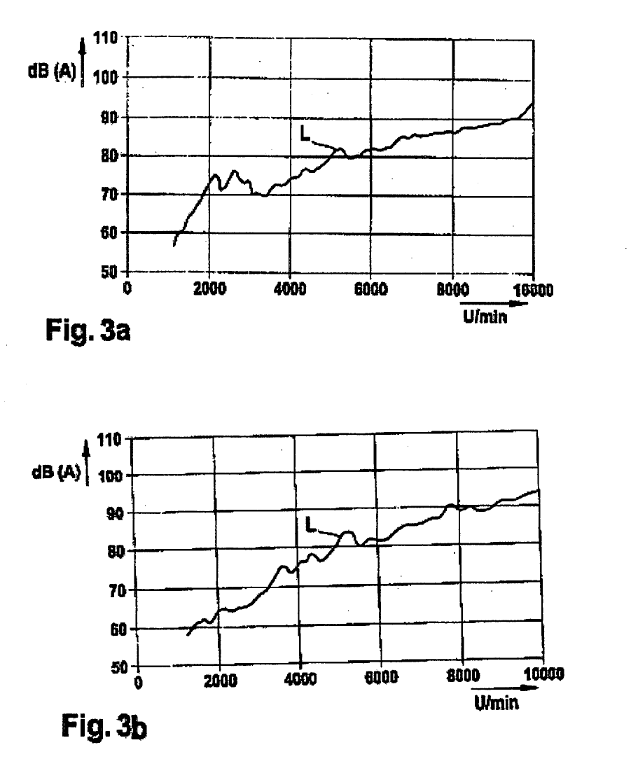

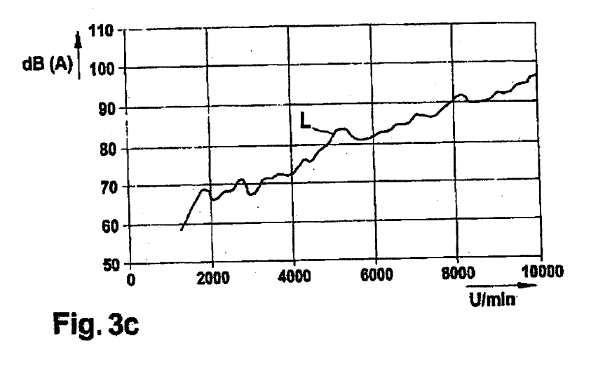

It is clear from the noise generation measurement graphs depicted in FIG. 3 that particularly in the lower speed range of 2000 rpm (generator speed), with winding ratios of 5:1 (b) and 4:2 (c), the airborne noise level L (db(A)) is sharply reduced in comparison to the non-offset winding arrangement according to FIG. 1a. Since a generator speed of 2000 rpm with a conventional turns ratio of approximately 3:1 corresponds to a motor speed of 600 to 700 rpm, the achieved noise reduction for vehicle occupants is markedly perceptible since the motor is still relatively quiet at idling speeds.

Another advantage of the offset winding is that it improves generator efficiency. This is due to the fact that the reduced harmonic content of the air gap magnetic field generates lower iron losses. A triangular arrangement of the three phase windings reduces the circular currents in the stator windings caused by the third harmonic, also reducing the associated losses. Furthermore, this reduces the ripple in the d.c. current supplied.

What is claimed is:

1. A stator of a three-phase generator, having a multi-strand stator winding,
wherein each of the m phase windings (19)
is comprised of a group (22), which
has a first coil (24) with coil sides (28, 29), which are contained in grooves (16) that are spaced apart from one another by 180° electrically and the first coil (24) has a particular number of turns (z_{w}),
has a second coil (27) with coil sides (29, 30), which are contained in grooves (16) that are spaced apart from one another by 180° electrically and the second coil (27) has a particular number of turns (z_{w});
the second coil (27) is offset from the first coil (24) in a first direction by 180°/m electrically, and
in accordance with the predetermined number of pole pairs, a corresponding number of groups (22) that are offset from one another by 360° electrically are arranged one after another in the stator.

2. The stator as recited in claim 1,
wherein the group (22) also has a third coil (50) that precedes the first coil (24) by 180°/m electrically in a second direction opposite from the first offset direction.

3. The stator as recited in claim 2,
wherein the third coil (50) has fewer turns than the first coil (24).

4. The stator as recited in claim 1,
wherein the phase windings (19) are comprised of multi-strand wire.

5. The stator as recited in claim 1,
wherein it is a flat packet stator.

6. The stator as recited in claim 5,
wherein the coil sides of the stator winding are shaped and adapted to a groove contour.

7. The stator as recited in claim 1,
wherein it is the stator of a machine with three phase windings, in particular a three-phase generator.
